(19) United States
(12) Patent Application Publication
(10) Pub. No.: US 2008/0177448 A1
(43) Pub. Date: Jul. 24, 2008

(54) SEAT APPARATUS FOR VEHICLE

(75) Inventors: Soichiro HOZUMI, Nagoya-shi (JP); Toshiro Maeda, Anjo-shi (JP); Koji Hattori, Toyota-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignees: AISIN SEIKI KABUSHIKI KAISHA, Kariya-shi (JP); TOYOTA JIDOSHA KABUSHIKI KAISHA, Toyota-shi (JP)

(21) Appl. No.: 12/016,490

(22) Filed: Jan. 18, 2008

(30) Foreign Application Priority Data
Jan. 22, 2007 (JP) 2007-011483

(51) Int. Cl. G06F 17/00

(52) U.S. Cl. 701/45

(57) ABSTRACT

A seat apparatus for a vehicle includes a vehicle information acquisition portion for acquiring information on a lateral acceleration applied to the vehicle and a steering angular velocity, a calculation portion for calculating a lateral acceleration for control used to calculate a control quantity for operating a side supporting portion by multiplying the lateral acceleration by a weighting coefficient when the steering angular velocity is equal to or greater than a threshold value, an output portion for outputting the lateral acceleration for control, and a control portion for calculating the control quantity for operating the side supporting portion and actuating the side supporting portion to be movable between a closed position and an open position in response to a support request based on the control quantity.

### CROSS REFERENCE TO RELATED APPLICATIONS

This application is based on and claims priority under 35 U.S.C. § 119 to Japanese Patent Application 2007-011483, filed on Jan. 22, 2007, the entire content of which is incorporated herein by reference.

### FIELD OF THE INVENTION

This invention generally relates to a seat apparatus for a vehicle.

### BACKGROUND

A known seat apparatus for a vehicle is disclosed in JP3131901B (U.S. Pat. No. 6,037,731A). According to the known seat apparatus for the vehicle, a lateral acceleration sensed by an occupant is calculated by weighting the lateral acceleration with a vehicle speed, based on which the seat apparatus for the vehicle calculates a control quantity of a side supporting portion. When the calculated control quantity becomes equal to or greater than a threshold value, a support operation is performed on the side supporting portion based on the calculated degree of the control quantity. In other words, according to the seat apparatus for the vehicle, a necessity of the support operation of the side supporting portion is considered to be low when the vehicle speed is low, and the higher the vehicle speed becomes, the higher the necessity becomes. According to the seat apparatus for the vehicle, therefore, a control of the side supporting portion, which meets the occupant's intention may be performed.

According to the above mentioned known seat apparatus for the vehicle, however, the side supporting portion is not always controlled to meet the occupant's intention. That is, when a driver makes a quick steering maneuver at a low vehicle speed, it is judged that the necessity of the support operation of the side supporting portion is low at the low vehicle speed, and thus the lateral acceleration weighted with the vehicle speed is calculated to be small. As a result, the calculated control quantity is smaller than the threshold value and consequently the support operation of the side supporting portion may not be performed. In such a case, the support operation of the side supporting portion needs to be performed because the occupant's body sways in a lateral direction of the vehicle even at the low vehicle speed.

Further, according to the above mentioned known seat apparatus for the vehicle, when the driver makes the quick steering maneuver at a certain vehicle speed, the calculated control quantity exceeds the threshold value, and thus the support operation of the side supporting portion is performed. However, a responsivity of the support operation of the side supporting portion is low because the lateral acceleration is applied to the vehicle after the driver maneuvers the steering wheel.

A need thus exists for a seat apparatus for a vehicle, which is not susceptible to the drawbacks mentioned above.

### SUMMARY OF THE INVENTION

According to an aspect of the present invention, a seat apparatus for a vehicle includes a vehicle information acquisition portion for acquiring information on a lateral acceleration applied to a vehicle and a steering angular velocity, a calculation portion for calculating a lateral acceleration for control used to calculate a control quantity for operating a side supporting portion by multiplying the lateral acceleration by a weighting coefficient when the steering angular velocity acquired by the vehicle information acquisition portion is equal to or greater than a threshold value, an output portion for outputting the lateral acceleration for control, and a control portion for calculating the control quantity for operating the side supporting portion according to the lateral acceleration for control outputted from the output portion and actuating the side supporting portion to be movable between a closed position and an open position in response to a support request based on the control quantity.

### BRIEF DESCRIPTION OF THE DRAWINGS

FIG. 1 is a perspective view of a seat apparatus for a vehicle in first, second and third embodiments.

FIG. 2 is a plan view of the seat apparatus for the vehicle in the first, second and third embodiments.

FIG. 3 is an electric connection diagram of the seat apparatus for the vehicle in the first, second and third embodiments.

FIG. 4 is a flowchart of a weighting control program relating to the seat apparatus for the vehicle in the first embodiment.

FIG. 5 illustrates a situation where the vehicle provided with the seat apparatus for the vehicle relating to the first, second and third embodiments is changing lanes to, for example, avoid an obstacle with a quick steering operation as indicated with arrows.

FIG. 6 is a graph of a steering angular velocity, a lateral acceleration and a lateral acceleration for control relating to the seat apparatus for the vehicle in the first embodiment.

FIG. 7 is a flowchart of the weighting control program relating to the seat apparatus for the vehicle in the second embodiment.

FIG. 8 is a graph of the steering angular velocity, the lateral acceleration and the lateral acceleration for control relating to the seat apparatus for the vehicle in the second embodiment.

FIG. 9 is a flowchart of the weighting control program relating to the seat apparatus for the vehicle in the third embodiment.

FIG. 10 is a graph of the steering angular velocity, the lateral acceleration and the lateral acceleration for control relating to the seat apparatus for the vehicle in the third embodiment.

### DETAILED DESCRIPTION

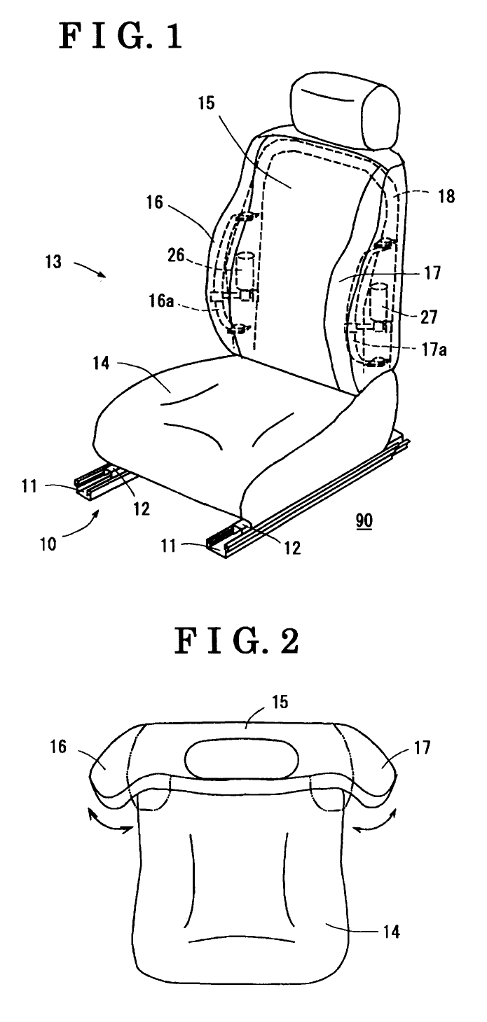

First, second and third embodiments of a seat apparatus for a vehicle (hereinafter referred to as a seat apparatus) related to the present invention will be described in accordance with the attached drawings. As illustrated in FIG. 1, the seat apparatus includes a seat slide device 10 and a seat 13. The seat slide device 10 includes, for example, a pair of lower rails 11 and a pair of upper rails 12 supported by the lower rails 11 so as to be slidable thereon. The lower rails 11 are fixed on a floor 90 so as to extend in a front-rear direction of the vehicle. Specifically, the seat 13 includes a seat cushion 14 on which an occupant is seated, and a seat back 15 that supports the occupant's back. Further, a right side supporting portion 16 and a left side supporting portion 17 are provided at right and left portions of the seat back 15, respectively, for stabilizing a posture of the occupant by pressing the upper body of the occupant on its sides. Additionally, as illustrated in FIG. 1, a right motor 26 and a left motor 27 are provided at right and left portions of a seat frame 18, respectively. Each of the right and left motors 26 and 27 includes a reduction mechanism. Furthermore, a right support frame 16a and a left support frame 17a are adapted to be pivoted by means of the right and left motors 26 and 27, respectively. Both right and left support frames 16a and 17a are pivoted by both right and left motors 26 and 27 being activated, and therefore the right and left side supporting portions 16 and 17 are moved to be in an open position, which is indicated with a solid line, and to be in a closed position, which is indicated with a chain double-dashed line illustrated in FIG. 2. The right side supporting portion 16 and the left side supporting portion 17 collectively serve as a side supporting portion.

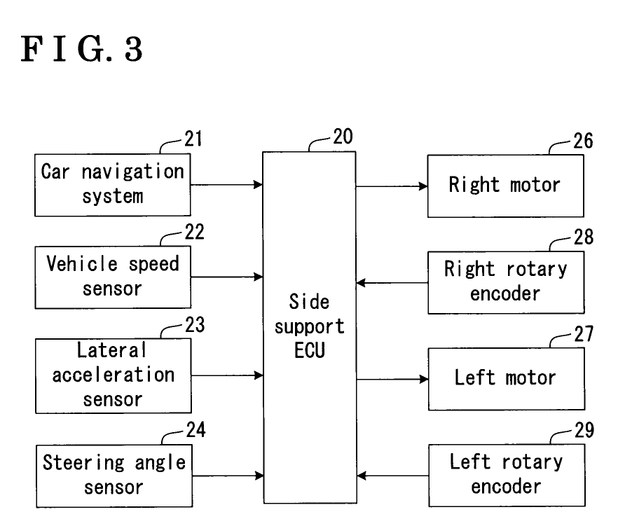

As shown in FIG. 3, a vehicle speed sensor 22, a lateral acceleration sensor 23 and a steering angle sensor 24 are connected to a side support ECU 20 serving as a control means (i.e., a control portion), and detection signals detected by the vehicle speed sensor 22, the lateral acceleration sensor 23 and the steering angle sensor 24 respectively are inputted to the side support ECU 20. A car navigation system 21 is also connected to the side support ECU 20 so that data including a position of the vehicle, a traveling direction of the vehicle and an electronic map are inputted from the car navigation system 21 to the side support ECU 20 as needed. Further, the right motor 26, the left motor 27, a right rotary encoder 28 and a left rotary encoder 29 are connected to the side support ECU 20. Drive signals are outputted to the right motor 26 and the left motor 27 from the side support ECU 20, and position signals for feedback are inputted to the side support ECU 20 from the right rotary encoder 28 and the left rotary encoder 29 provided at the support motors 26 and 27 respectively.

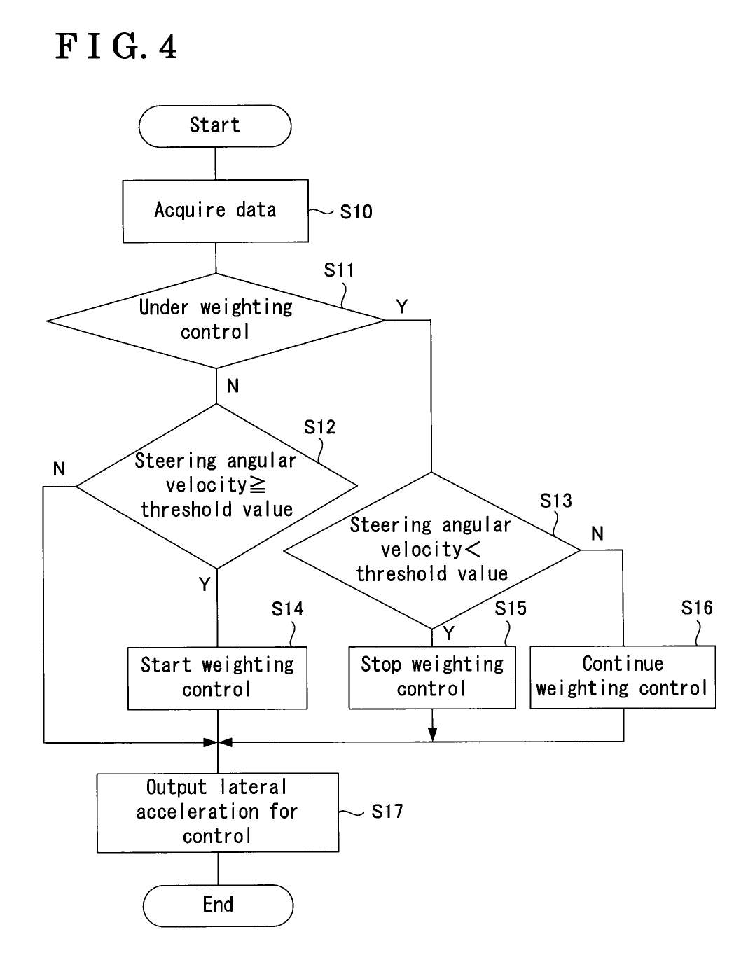

Procedures at the seat apparatus in the first embodiment will be described referring to FIG. 4. When an execution of a weighting control program begins, a lateral acceleration Gi and a steering angle Di are inputted to the side support ECU 20 from the lateral acceleration sensor 23 and the steering angle sensor 24 respectively in Step S10 for calculating a steering angular velocity Vd based on the steering angle Di. Step S10 serves as a vehicle information acquisition means S10 (i.e., a vehicle information acquisition portion) for acquiring the lateral acceleration Gi applied to the vehicle and the steering angular velocity Vd.

In Step S11, it is determined whether or not the weighting control is currently performed. When the weighting control is currently performed (i.e., YES as indicated by “Y” in FIG. 4), Step S13 is executed. When the weighting control is not currently performed (i.e., NO as indicated by “N” in FIG. 4), Step S12 is executed. In Step S12, the steering angular velocity Vd and a threshold value Vth are compared, and Step S14 is executed when the steering angular velocity Vd is equal to or greater than the threshold value Vth (i.e., YES). When the steering angular velocity Vd is smaller than the threshold value Vth (i.e., NO), the weighting control is determined to be unnecessary and a value of the lateral acceleration Gi is deemed to be a lateral acceleration for control Gc (a lateral acceleration used to calculate a control quantity to operate the side supporting portion 16, 17). For the threshold value Vth, for example, 43 degrees per second is applicable.

In Step S14, the weighting control begins. Specifically, the lateral acceleration Gi is multiplied by a weighting coefficient K to acquire the lateral acceleration for control Gc. For the weighting coefficient K, for example, 1.5 is applicable. Step S14 and later described Step S16 serve as a calculation means S14, S16, S21, S22, S32 (i.e., a calculation portion) for calculating the lateral acceleration for control Gc.

In Step S13, the steering angular velocity Vd and the threshold value Vth are compared, and Step S15 is executed when the steering angular velocity Vd is smaller than the threshold value Vth (i.e., YES). When the steering angular velocity Vd is equal to or greater than the threshold value Vth (i.e., NO), Step S16 is executed. In Step S15, the weighting control is stopped and the value of the lateral acceleration Gi is deemed to be the lateral acceleration for control Gc. In Step S16, the weighting control is continued and the lateral acceleration for control Gc is calculated by multiplying the lateral acceleration Gi by the weighting coefficient K. Step S16 and above mentioned Step S14 serve as the calculation means S14, S16, S21, S22, S32.

In Step S17, the lateral acceleration for control Gc is outputted and the weighting control ends. In cases where Step S14 or S16 is executed as described above, the lateral acceleration for control Gc is calculated by multiplying the lateral acceleration Gi by the weighting coefficient K. In the other cases, the lateral acceleration Gi itself serves as the lateral acceleration for control Gc. The lateral acceleration for control Gc is inputted to a program module. A control quantity of the side supporting portion 16, 17 is outputted by the program module based on the lateral acceleration for control Gc, and thus the side supporting portion 16, 17 is controlled to be in the open or closed position. Step S17 serves as an output means S17 (i.e., an output portion) for outputting the lateral acceleration for control Gc.

According to the seat apparatus in the first embodiment, the lateral acceleration Gi applied to the vehicle and the steering angle Di are acquired in Step S10, and when the steering angular velocity Vd is equal to or greater than the threshold value Vth, the lateral acceleration for control Gc is calculated by multiplying the lateral acceleration Gi by the weighting coefficient K in Step S14 or Step S16. Then, the lateral acceleration for control Gc is outputted in Step S17. Therefore, when a driver of the vehicle makes a quick steering maneuver at a low vehicle speed, the lateral acceleration for control Gc is calculated in Step S14 or S16 by multiplying the lateral acceleration Gi by the weighting coefficient K and then outputted in Step S17. Then, the control quantity of the side supporting portion 16, 17 calculated based on the lateral acceleration for control Gc is outputted, thereby ensuring the support operation of the side supporting portion 16, 17.

According to the seat apparatus in the embodiment, since the lateral acceleration for control Gc is calculated by multiplying the lateral acceleration Gi by the weighting coefficient K when the steering angular velocity Vd is equal to or greater than the threshold value Vth, a value of the lateral acceleration for control Gc follows a steering operation even when the driver operates a steering wheel quickly. Therefore, the seat apparatus according to the embodiment allows the support operation of the side supporting portion 16, 17 that meets the intention of the occupant, whilst improving responsivity of the support operation.

A value of the weighting coefficient K in Step S14 or S16 may be constant or may be changed according to the steering angular velocity Vd. When the weighting coefficient K is modified according to the steering angular velocity Vd, an unnecessary increment in the control quantity of the side supporting portion 16, 17 is prevented whilst still maintaining the responsivity of the support operation thereof. Here, for example, the weighting coefficient K may be 1.3 when the steering angular velocity Vd ranges from 40 degrees per second to 60 degrees per second and may be 1.5 when the steering angular velocity Vd is equal to or greater than 60 degrees per second.

According to the embodiment, the lateral acceleration Gi is inputted from the lateral acceleration sensor 23, however, a vehicle speed Vi and the steering angle Di may be input from the vehicle speed sensor 22 and the steering angle sensor 24 respectively for calculating the lateral acceleration Gi based on the vehicle speed Vi and the steering angle Di.

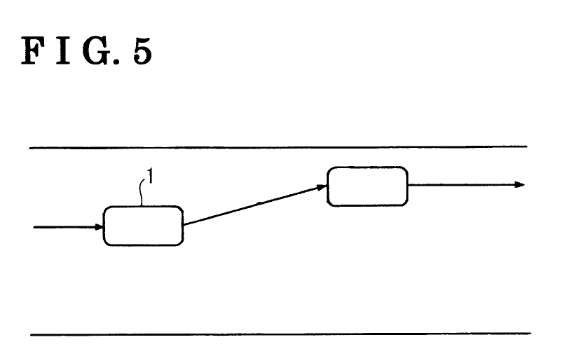

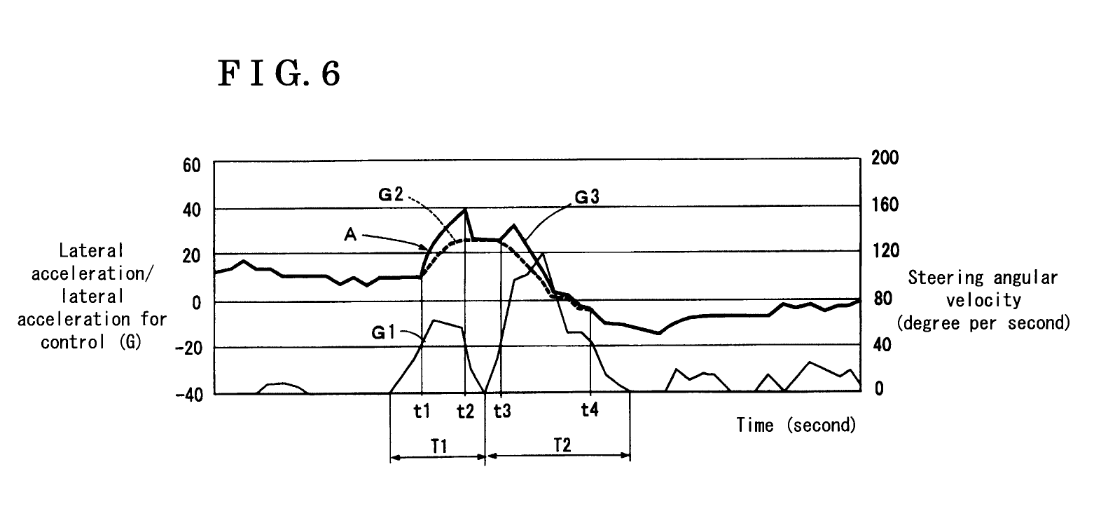

The weighting control performed in the seat apparatus is described referring to FIGS. 4, 5 and 6. In FIG. 6, Line G1 indicates the steering angular velocity Vd, Line G2 indicates the lateral acceleration Gi, and Line G3 indicates the lateral acceleration for control Gc in the situation illustrated in FIG. 5. Time T1 corresponds to an elapsed time during which driver is steering the steering wheel and time T2 corresponds to an elapsed time during which the driver is counter steering. In FIG. 4, the threshold value Vth in Steps S12 and S13 is 43 degrees per second and the weighting coefficient K in Steps S14 and S16 is 1.5.

Because the steering angular velocity Vd is smaller than the threshold value Vth (43 degrees per second) until time t1, the lateral acceleration Gi is deemed to be the lateral acceleration for control Gc and then outputted in Steps S12 and S17. Therefore, levels of the lateral acceleration Gi (indicated by Line G2) and the lateral acceleration for control Gc (indicated by Line G3) are identical up to the time t1.

When the driver begins steering the steering wheel and the steering angular velocity Vd becomes equal to or greater than the threshold value Vth (43 degrees per second) at the time t1, the weighting control begins in Steps S12, S14 and S17. Here, the lateral acceleration for control Gc is calculated by multiplying the lateral acceleration Gi by the weighting coefficient K (1.5) and the calculated lateral acceleration for control Gc is outputted. Thereafter, the weighting control is continued in Steps S13, S16 and S17. Here again, the lateral acceleration for control Gc is calculated by multiplying the lateral acceleration Gi by the weighting coefficient K (1.5). Here, the lateral acceleration for control Gc is calculated to be greater than the lateral acceleration Gi as shown in part A of Line G3. This shows that controlling the side supporting portion 16, 17 based on the lateral acceleration for control Gc allows a more reliable support operation and the higher responsivity compared to controlling the side supporting portion 16, 17 based on the lateral acceleration Gi.

At time t2, the weighting control is stopped and the lateral acceleration Gi is outputted as the lateral acceleration for control Gc in Steps S13, S15 and S17 because the steering angular velocity Vd becomes smaller than the threshold value Vth (43 degrees per second). Thereafter, the lateral acceleration Gi is outputted as the lateral acceleration for control Gc as a result of Steps S12 and S17. However, after the time t2, the value of the lateral acceleration for control Gc (indicated by Line G3) gradually decreases to the value of the lateral acceleration Gi (indicated by Line G2) because the lateral acceleration for control Gc is filtered in Step S17 before being outputted.

At time t3, the steering angular velocity Vd becomes equal to or greater than the threshold value Vth (43 degrees per second) again and the weighting control in Steps S12, S14 and S17 resumes. Thereafter, the weighting control is continued in Steps S13, S16 and S17. Here, the lateral acceleration for control Gc is calculated by multiplying the lateral acceleration Gi by the weighting coefficient K (1.5).

At time t4, the weighting control is stopped and the lateral acceleration Gi is outputted as the lateral acceleration for control Gc in Steps S13, S15 and S17 because the steering angular velocity Vd becomes smaller than the threshold value Vth (43 degrees per second). Thereafter, the lateral acceleration Gi is outputted as the lateral acceleration for control Gc as the result of Steps S12 and S17.

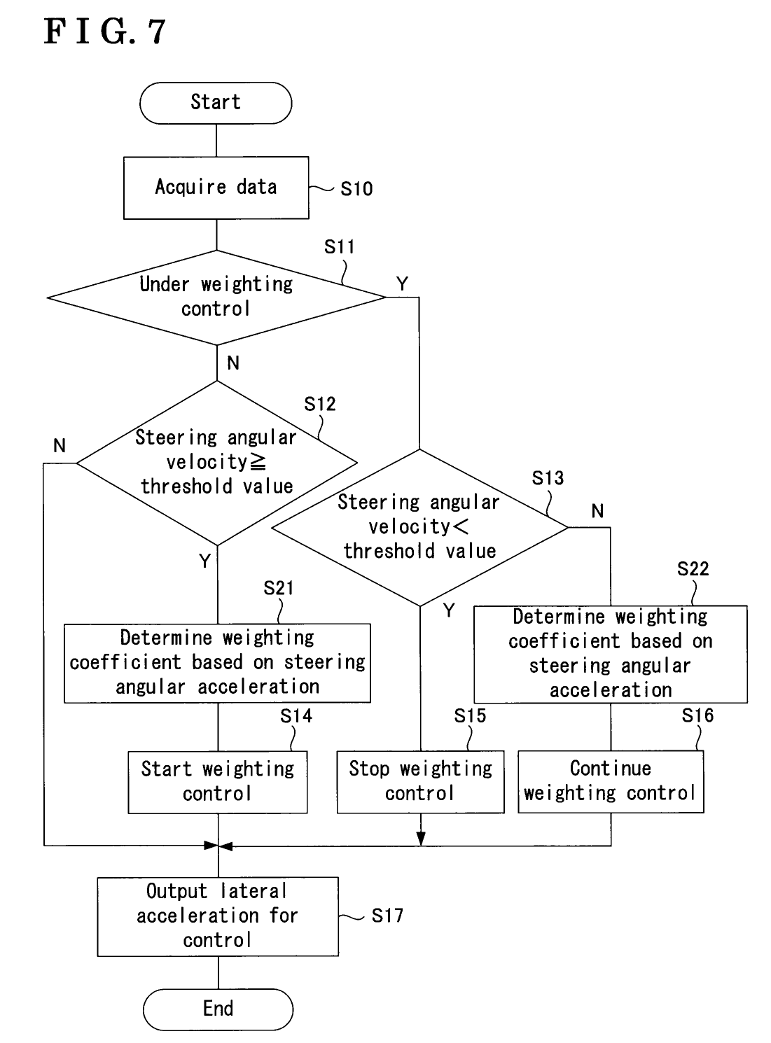

Next, the procedures at the seat apparatus in the second embodiment will be described referring to FIG. 7. In FIG. 7, identical reference numerals as shown in FIG. 4 designate identical or corresponding procedures, and therefore, descriptions of these procedures are omitted.

In Steps S21 and S22, the weighting coefficient K is determined based on a steering angular acceleration Gd. When the steering angular acceleration Gd is a positive value, that is, at the beginning of the steering operation of the steering wheel or a counter steering operation, the weighting coefficient K may be, for example, 1.5. When the steering angular acceleration Gd is a negative value, that is, at the end of the steering operation of the steering wheel or the counter steering operation, the weighting coefficient K may be, for example, 1.2. Steps S21 and S22 serve as the calculation means S14, S16, S21, S22, S32. The steering angular acceleration Gd is calculated based on the steering angular velocity Vd.

According to the seat apparatus in the second embodiment, the weighting coefficient K is modified according to the steering angular acceleration Gd in Steps S21 or S22, which prevents the unnecessary increment in the control quantity of the side supporting portion 16, 17 whilst maintaining the responsivity of the support operation. Other functions and effects are identical to the functions and effects described in the first embodiment.

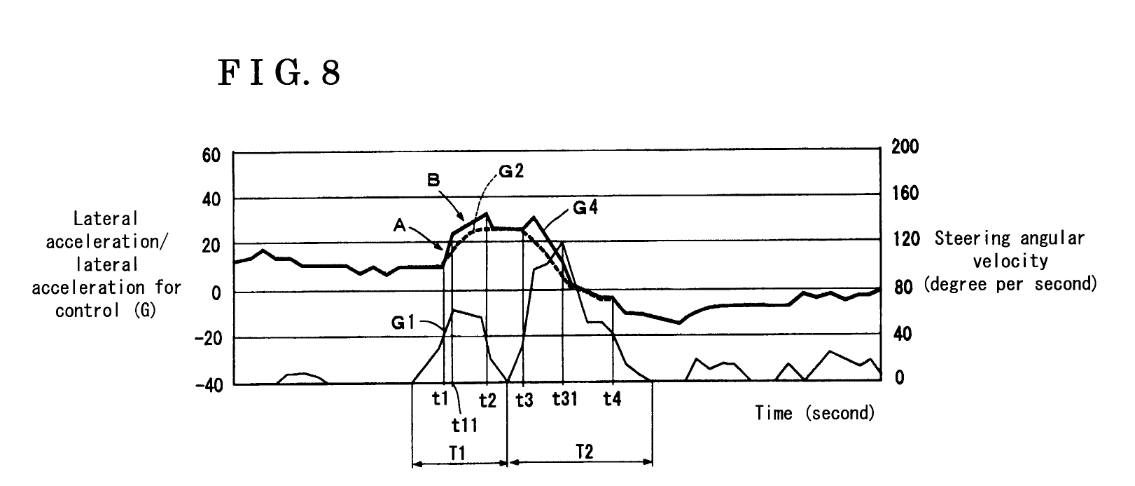

The weighting control performed in the seat apparatus is described referring to FIGS. 5, 7 and 8. In FIG. 8, Line G1 indicates the steering angular velocity Vd, Line G2 indicates the lateral acceleration Gi, and Line G4 indicates the lateral acceleration for control Gc in the situation illustrated in FIG. 5. In FIG. 8, identical reference numerals as shown in FIG. 6 designate identical or corresponding graphs or times, and therefore, descriptions of these graphs or times are omitted. In FIG. 7, In Steps S12 and S13, the threshold value Vth is 43 degrees per second. In Steps S21 and S22, the weighting coefficient K is 1.5 when the steering angular acceleration Gd is a positive value and 1.2 when the steering angular acceleration Gd is a negative value.

Because the steering angular velocity Vd is smaller than the threshold value Vth (43 degrees per second) until the time t1, the lateral acceleration Gi is deemed to be the lateral acceleration for control Gc and outputted in Steps S12 and S17. Therefore, levels of the lateral acceleration Gi (indicated by Line G2) and the lateral acceleration for control Gc (indicated by Line G4) are identical up to the time t1.

When the driver begins steering the steering wheel and the steering angular velocity Vd becomes equal to or greater than the threshold value Vth (43 degrees per second) at the time t1, the weighting control begins in Steps S12, S21, S14 and S17. Here, the steering angular acceleration Gd is a positive value (the beginning of the steering operation of the steering wheel), therefore the lateral acceleration for control Gc is calculated by multiplying the lateral acceleration Gi by the weighting coefficient K (1.5) and the calculated lateral acceleration for control Gc is outputted. Thereafter, the weighting control is continued in Steps S13, S22, S16 and S17. Here again, the steering angular acceleration Gd is a positive value (the beginning of the steering operation of the steering wheel), therefore the lateral acceleration for control Gc is calculated by multiplying the lateral acceleration Gi by identical weighting coefficient K (1.5) as used in Steps S12, S21, S14 and S17. Similarly to the first embodiment, the lateral acceleration for control Gc is calculated to be greater than the lateral acceleration Gi as shown in part A of Line G4.

At time t11, the weighting control is continued in Steps S13, S22, S16 and S17, however, the steering angular acceleration Gd is a negative value (the end of the steering operation of the steering wheel), therefore the lateral acceleration for control Gc is calculated by multiplying the lateral acceleration Gi by the coefficient K (1.2). Then the calculated lateral acceleration for control Gc is outputted. Consequently, as shown in part B of Line G4, Line G4 indicating the lateral acceleration for control Gc approximates Line G2 indicating the lateral acceleration Gi, thereby preventing the unnecessary increment in the control quantity of the side supporting portion 16, 17.

At the time t2, the weighting control is stopped and the lateral acceleration Gi is outputted as the lateral acceleration for control Gc in Steps S13, S15 and S17 because the steering angular velocity Vd becomes smaller than the threshold value Vth (43 degrees per second). Thereafter, the lateral acceleration Gi is outputted as the lateral acceleration for control Gc as the result of Steps S12 and S17. However, after the time t2, the value of the lateral acceleration for control Gc (indicated by Line G4) gradually decreases down to the value of the lateral acceleration Gi (indicated by Line G2) because the lateral acceleration for control Gc is filtered in Step S17 before being outputted.

At the time t3, the weighting control resumes in Steps S12, S21, S14 and S17 because the steering angular velocity Vd becomes equal to or greater than the threshold value Vth (43 degrees per second). Thereafter, the weighting control is continued in Steps S13, S22, S16 and S17. Here, the steering angular acceleration Gd is a positive value, (the beginning of the counter steering operation), therefore the lateral acceleration for control Gc is calculated by multiplying the lateral acceleration Gi by the weighting coefficient K (1.5), and the calculated lateral acceleration for control Gc is outputted.

At time t31, the weighting control is continued in Steps S13, S22, S16 and S17, however, the steering angular acceleration Gd is a negative value (the end of the counter steering operation), therefore the lateral acceleration for control Gc is calculated by multiplying the lateral acceleration Gi by the coefficient K (1.2). Then the calculated lateral acceleration for control Gc is outputted.

At the time t4, the weighting control is stopped and the lateral acceleration Gi is outputted as the lateral acceleration for control Gc in Steps S13, S15 and S17 because the steering angular velocity Vd becomes smaller than the threshold value Vth (43 degrees per second). Thereafter, the lateral acceleration Gi is outputted as the lateral acceleration for control Gc as the result of Steps S12 and S17.

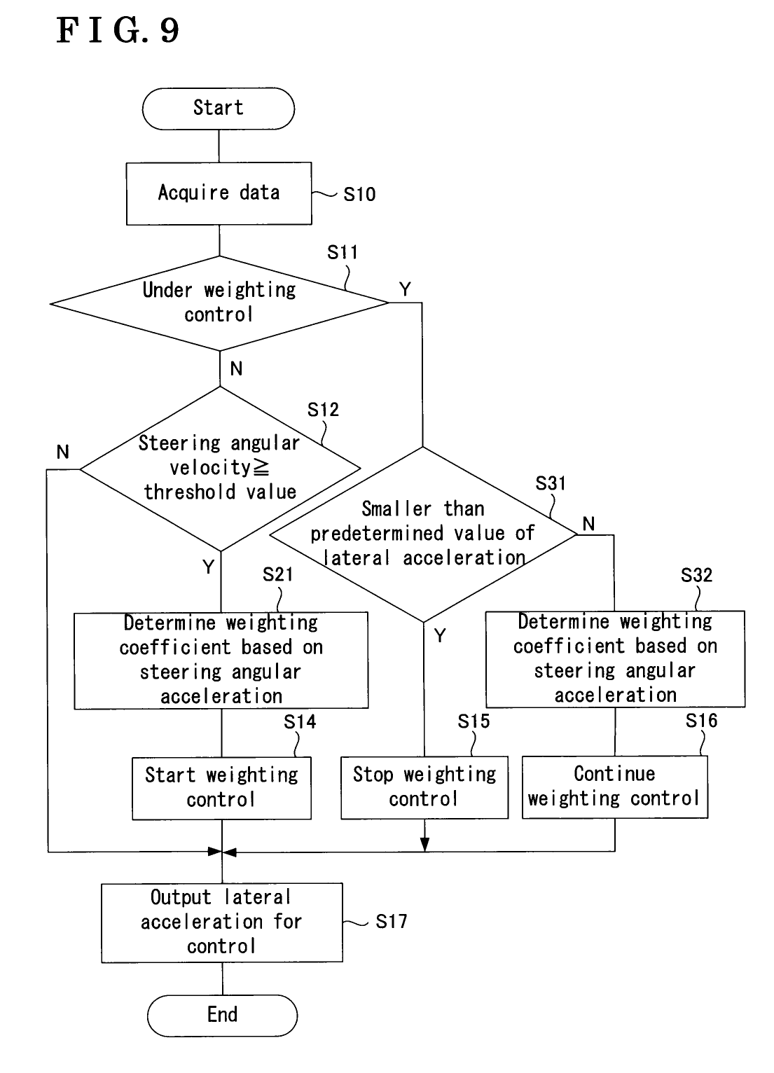

Next, the procedures at the seat apparatus in the third embodiment will be described referring to FIG. 9. In FIG. 9, identical reference numerals shown as in FIG. 7 designate identical or corresponding procedures, and therefore, the descriptions of these procedures are omitted.

In Step S31, it is judged whether or not the lateral acceleration Gi is smaller than a predetermined value. When the lateral acceleration Gi is smaller than the predetermined value (i.e., YES), Step S15 is executed. When the lateral acceleration Gi is equal to or greater than the predetermined value (i.e., NO), Step S32 is executed. That is, the weighting control is continued until the lateral acceleration Gi becomes smaller than the predetermined value.

In Step S32, the weighting coefficient K is determined based on the steering angular acceleration Gd. When the steering angular acceleration Gd is a positive value, that is, at the beginning of the steering operation of the steering wheel, the weighting coefficient K may be, for example, 1.5. When the steering angular acceleration Gd is a negative value, that is, at the end of the steering operation of the steering wheel, the weighting coefficient K may be, for example, 1.2. However, once the steering angular acceleration Gd becomes a negative value, the weighting coefficient K remains constant at, for example, 1.2 until the current weighting control ends. More specifically, although the steering angular acceleration Gd becomes a positive value when the driver finishes steering the steering wheel and then begins counter steering, the weighting coefficient K is not modified. Step S32 serves as the calculation means S14, S16, S21, S22, S32.

According to the seat apparatus in the third embodiment, when the lateral acceleration Gi applied to the vehicle becomes smaller than the predetermined value, the weighting on the lateral acceleration Gi is stopped, thereby applying the lateral acceleration for control Gc which meets the actual lateral acceleration Gi. Thus, the support operation of the side supporting portion 16, 17 is performed so that the occupant will feel more comfortable. Other functions and effects are identical to the functions and effects shown in the first embodiment.

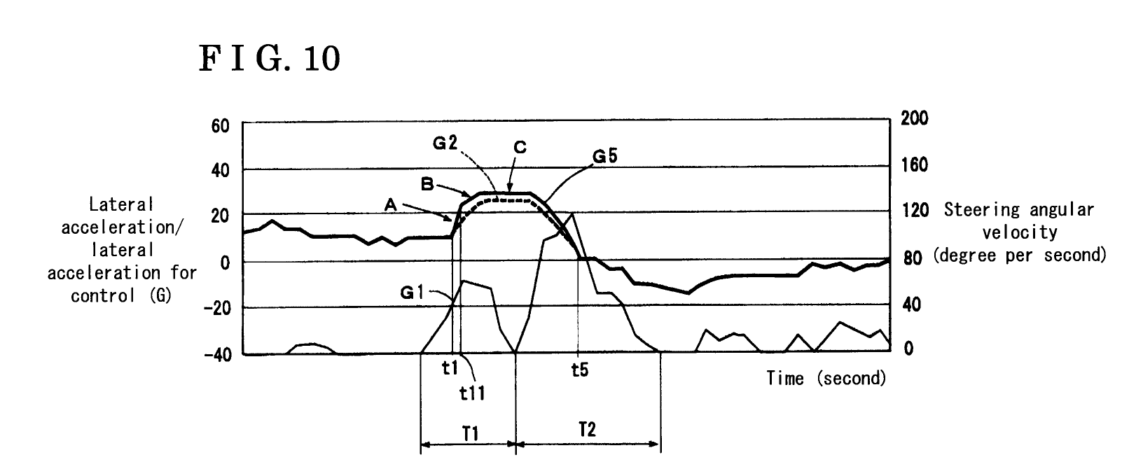

The weighting control performed in the seat apparatus is described referring to FIGS. 5, 9 and 10. In FIG. 10, Line G1 indicates the steering angular velocity Vd, Line G2 indicates the lateral acceleration Gi, and Line G5 indicates the lateral acceleration for control Gc in the situation illustrated in FIG. 5. In FIG. 10, identical reference numerals as shown in FIG. 8 designate identical or corresponding graphs or times, and therefore, the descriptions of these graphs or times are omitted. In FIG. 9, The threshold value Vth in Step S12 is 43 degrees per second and the predetermined value in Step S31 is, for example, 0.05 G. In Steps S21 and S32, the weighting coefficient K is 1.5 when the steering angular acceleration Gd is a positive value and 1.2 when the steering angular acceleration Gd is a negative value. However, once the steering angular acceleration Gd becomes a negative value in Step S32, the weighting coefficient K remains constant at 1.2 until the current weighting control ends.

Because the steering angular velocity Vd is smaller than the threshold value Vth (43 degrees per second) until the time t1, the lateral acceleration Gi is deemed to be the lateral acceleration for control Gc and outputted in Steps S12 and S17. Therefore, levels of the lateral acceleration Gi (indicated by Line G2) and the lateral acceleration for control Gc (indicated by Line G5) are identical up to the time t1.

When the driver begins steering the steering wheel and the steering angular velocity Vd becomes equal to or greater than the threshold value Vth (43 degrees per second) at the time t1, the weighting control begins in Steps S12, S21, S14 and S17. Here, the steering angular acceleration Gd is a positive value, (the beginning of the steering operation of the steering wheel), therefore the lateral acceleration for control Gc is calculated by multiplying the lateral acceleration Gi by the weighting coefficient K (1.5) and the calculated lateral acceleration for control Gc is outputted. Thereafter, the weighting control is continued in Steps S31, S32, S16 and S17. Here again, the steering angular acceleration Gd is a positive value, (the beginning of the steering operation of the steering wheel), therefore the lateral acceleration for control Gc is calculated by multiplying the lateral acceleration Gi by identical weighting coefficient K (1.5) as used in Steps S12, S21, S14 and S17. Here, similarly to the first embodiment, the lateral acceleration for control Gc is calculated to be greater than the lateral acceleration Gi as shown in part A of Line G5.

At the time t11, the weighting control is continued in Steps S31, S32, S16 and S17, however, the steering angular acceleration Gd is a negative value, (the end of the steering operation of the steering wheel), therefore the lateral acceleration for control Gc is calculated by multiplying the lateral acceleration Gi by the weighting coefficient K (1.2). Then the calculated lateral acceleration for control Gc is outputted. Thereafter, the weighting control is continued in Steps S31, S32, S16 and S17, however, the weighting coefficient K is fixed at 1.2 because the steering angular acceleration Gd has already become a negative value.

Consequently, as shown in part B of Line G5, a shape of Line G5 indicating the lateral acceleration for control Gc becomes similar to a shape of Line G2 indicating the lateral acceleration Gi, thereby preventing the unnecessary increment in the control quantity of the side supporting portion 16, 17. Further, as shown in part C of Line G5, a range of change of Line G5 indicating the lateral acceleration for control Gc approximates a range of change of Line G2 indicating lateral acceleration Gi, thereby allowing the lateral acceleration for control Gc which meets the actual lateral acceleration Gi.

At time t5, the weighting control is stopped and the lateral acceleration Gi is outputted as the lateral acceleration for control Gc in Steps S31, S15 and S17 because the lateral acceleration Gi becomes smaller than the predetermined value (0.05 G). Thereafter, the lateral acceleration Gi is outputted as the lateral acceleration for control Gc as the result of Steps S12 and S17.

The above described seat apparatus according to the present invention is not limited to the first, second or third embodiment, and various modifications may be made without departing from the spirit of the present invention.

According to the described subject matter of the seat apparatus, in Step S10, information on the lateral acceleration Gi applied to the vehicle 1 and the steering angular velocity Vd is acquired, and in Step S14, S16, S21, S22, S32, the lateral acceleration for control Gc is calculated by multiplying the lateral acceleration Gi by the weighting coefficient K when the steering angular velocity Vd is equal to or greater than the threshold value. Then, the lateral acceleration for control Gc is outputted in Step S17. Consequently, when the driver of the vehicle makes the quick steering maneuver at the low vehicle speed, the lateral acceleration for control Gc that is calculated in Step S14, S16, S21, S22, S32 by multiplying the lateral acceleration Gi by the weighting coefficient K is outputted in Step S17. Then, the control quantity of the side supporting portion 16, 17, which is calculated based on the lateral acceleration for control Gc, is outputted thereby allowing the reliable support operation of the side supporting portion 16, 17.

Furthermore, according to the described subject matter, when the steering angular velocity Vd is equal to or greater than the threshold value Vth, the lateral acceleration for control Gc is calculated by multiplying the lateral acceleration Gi by the weighting coefficient K, and thus the value of the lateral acceleration for control Gc follows the steering operation even when the driver operates the steering wheel quickly. Consequently, the support operation of the side supporting portion 16, 17 that meets the intention of the occupant is allowed, whilst improving responsivity of the support operation.

According to the described subject matter of the seat apparatus, the value of the weighting coefficient K is changed in Step S14, S16, S21, S22, S32, according to a value of the steering angular acceleration Gd calculated based on a value of the steering angular velocity Vd.

According to the described subject matter of the seat apparatus, the weighting coefficient K is changed in Step S14, S16, S21, S22, S32 according to the steering angular acceleration Gd, thereby preventing the unnecessary increment in the control quantity of the side supporting portion 16, 17 whilst still maintaining the responsivity of the support operation thereof.

According to the described subject matter of the seat apparatus, the value of the weighting coefficient K is changed in Step S14, S16, S21, S22, S32 according to the value of the steering angular velocity Vd.

According to the described subject matter of the seat apparatus, the weighting coefficient K is changed in Step S14, S16, S21, S22, S32 according to the steering angular velocity Vd. This also prevents the unnecessary increment in the control quantity of the side supporting portion 16, 17, whilst maintaining the responsivity of the support operation.

According to the described subject matter of the seat apparatus, in Step S14, S16, S21, S22, S32, weighting the lateral acceleration Gi is stopped when the value of the lateral acceleration Gi applied to the vehicle 1 becomes smaller than the predetermined value.

According to the described subject matter of the seat apparatus, in Step S14, S16, S21, S22, S32, weighting the lateral acceleration Gi is stopped when the lateral acceleration G1 applied to the vehicle 1 becomes smaller than the predetermined value, thereby applying the lateral acceleration for control Gc which meets the actual lateral acceleration Gi. Thus, the support operation of the side supporting portion 16, 17 is performed so that the occupant will feel more comfortable.

According to the described subject matter of the seat apparatus, the seat apparatus for the vehicle includes the seat cushion 14 and the seat back 15 on which the side supporting portion 16, 17 is provided for supporting the occupant of the vehicle 1. The side supporting portion 16, 17 restrains the occupant sitting on the seat cushion 14 by being moved to the closed position and releases the occupant by being moved to the open position in response to the support request based on the control quantity.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A seat apparatus for a vehicle, comprising:
a vehicle information acquisition means for acquiring information on a lateral acceleration applied to the vehicle and a steering angular velocity;
a calculation means for calculating a lateral acceleration for control used to calculate a control quantity for operating a side supporting portion by multiplying the lateral acceleration by a weighting coefficient when the steering angular velocity acquired by the vehicle information acquisition means is equal to or greater than a threshold value;
an output means for outputting the lateral acceleration for control; and
a control means for calculating the control quantity for operating the side supporting portion according to the lateral acceleration for control outputted from the output means and actuating the side supporting portion to be movable between a closed position and an open position in response to a support request based on the control quantity.

2. The seat apparatus for the vehicle according to claim 1 wherein a value of the weighting coefficient is changed, by the calculation means for calculating the lateral acceleration for control, according to a value of a steering angular acceleration calculated based on a value of the steering angular velocity.

3. The seat apparatus for the vehicle according to claim 1 wherein a value of the weighting coefficient is changed, by the calculation means for calculating the lateral acceleration for control, according to a value of the steering angular velocity.

4. The seat apparatus for the vehicle according to claim 2 wherein the value of the weighting coefficient is changed, by the calculation means for calculating the lateral acceleration for control, according to the value of the steering angular velocity.

5. The seat apparatus for the vehicle according to claim 1 wherein the calculation means for calculating the lateral acceleration for control stops weighting the lateral acceleration when a value of the lateral acceleration applied to the vehicle becomes smaller than a predetermined value.

6. The seat apparatus for the vehicle according to claim 2 wherein the calculation means for calculating the lateral acceleration for control stops weighting the lateral acceleration when a value of the lateral acceleration applied to the vehicle becomes smaller than a predetermined value.

7. The seat apparatus for the vehicle according to claim 3 wherein the calculation means for calculating the lateral acceleration for control stops weighting the lateral acceleration when a value of the lateral acceleration applied to the vehicle becomes smaller than a predetermined value.

8. The seat apparatus for the vehicle according to claim 4 wherein the calculation means for calculating the lateral acceleration for control stops weighting the lateral acceleration when a value of the lateral acceleration applied to the vehicle becomes smaller than a predetermined value.

9. The seat apparatus for the vehicle according to claim 1 further comprising a seat cushion and a seat back on which the side supporting portion is provided for supporting an occupant of the vehicle, the side supporting portion restraining the occupant sitting on the seat cushion by being moved to the closed position and releasing the occupant by being moved to the open position in response to the support request based on the control quantity.

10. The seat apparatus for the vehicle according to claim 2 further comprising a seat cushion and a seat back on which the side supporting portion is provided for supporting an occupant of the vehicle, the side supporting portion restraining the occupant sitting on the seat cushion by being moved to the closed position and releasing the occupant by being moved to the open position in response to the support request based on the control quantity.

11. The seat apparatus for the vehicle according to claim 3 further comprising a seat cushion and a seat back on which the side supporting portion is provided for supporting an occupant of the vehicle, the side supporting portion restraining the occupant sitting on the seat cushion by being moved to the closed position and releasing the occupant by being moved to the open position in response to the support request based on the control quantity.

12. The seat apparatus for the vehicle according to claim 4 further comprising a seat cushion and a seat back on which the side supporting portion is provided for supporting an occupant of the vehicle, the side supporting portion restraining the occupant sitting on the seat cushion by being moved to the closed position and releasing the occupant by being moved to the open position in response to the support request based on the control quantity.

13. The seat apparatus for the vehicle according to claim 5 further comprising a seat cushion and a seat back on which the side supporting portion is provided for supporting an occupant of the vehicle, the side supporting portion restraining the occupant sitting on the seat cushion by being moved to the closed position and releasing the occupant by being moved to the open position in response to the support request based on the control quantity.

14. The seat apparatus for the vehicle according to claim 6 further comprising a seat cushion and a seat back on which the side supporting portion is provided for supporting an occupant of the vehicle, the side supporting portion restraining the occupant sitting on the seat cushion by being moved to the closed position and releasing the occupant by being moved to the open position in response to the support request based on the control quantity.

15. The seat apparatus for the vehicle according to claim 7 further comprising a seat cushion and a seat back on which the side supporting portion is provided for supporting an occupant of the vehicle, the side supporting portion restraining the occupant sitting on the seat cushion by being moved to the closed position and releasing the occupant by being moved to the open position in response to the support request based on the control quantity.

16. The seat apparatus for the vehicle according to claim 8 further comprising a seat cushion and a seat back on which the side supporting portion is provided for supporting an occupant of the vehicle, the side supporting portion restraining the occupant sitting on the seat cushion by being moved to the closed position and releasing the occupant by being moved to the open position in response to the support request based on the control quantity.
